(19) United States
(12) Patent Application Publication
(10) Pub. No.: US 2026/0087928 A1
(43) Pub. Date: Mar. 26, 2026

(54) ENHANCED ROADWAY AND TRAFFIC MANAGEMENT WITH CONNECTED SIGNAGE DISPLAYING WARNING INDICATORS OF TRAFFIC STATUS FOR POINTS OF ROADWAY EGRESS

(71) Applicant: ILAN ISRAELY, LOS ANGELES, CA (US)

(72) Inventor: ILAN ISRAELY, LOS ANGELES, CA (US)

(21) Appl. No.: 18/893,379

(22) Filed: Sep. 23, 2024

(51) Int. Cl. G08G 1/09; G08G 1/01

(52) U.S. Cl. CPC G08G 1/091; G08G 1/0116; G08G 1/0141

(57) ABSTRACT

The invention discloses a framework for roadway and traffic management. The framework analyzes multiple types of input data to assess traffic conditions and determine a traffic status that indicates an availability of roadway exits or points of egress. The framework generates signals that provide visual warning indicators, such as LED lights, on roadway signage to inform motorists of such exit availability. A central roadway information management system continually models traffic conditions and updates such visual warning indicators on signage throughout the roadway network.

### FIELD OF THE INVENTION

The present invention relates to highway and roadway communications and traffic information management. Specifically, the present invention relates to an approach to automatically and electronically notifying motorists of exit availability and other traffic status-related information through a connected system of signs that provide visual indicators for particular exits on such signs.

### BACKGROUND OF THE INVENTION

Current highway signage typically lists the next several upcoming exits, but does not provide any real-time status of the availability of each exit. There is also no way of continually updating signage to provide information to motorists as to the availability of each exit that is consistent across multiple roadway signs.

Permanent roadway information boards, or mobile signage equipment, are often used to separately warn drivers of exit closures and provide information to motorists about the status of exits and roadway generally. These existing methods however are provided either on overhead electronic signs (or signs configured permanently at the side of the roadway), or made via signs that are temporarily placed locations at the side of the roadway. In either case, such existing approaches are generally unsafe as they provide an additional distraction for motorists away from the roadway itself, and often themselves result in congestion due to motorists slowing down to read them.

Accordingly, there is a need for improvements in roadway signage that provides motorists with quick and effective information about traffic conditions on a roadway generally, and about the status or availability of upcoming exits or egress points. There is a further need in the existing art for an automated approach that generates visual warning indicators on such roadway signage, at least for information about the status or availability of upcoming exits or egress points. There is still a further need in the existing art for an approach that updates signage across a roadway network so that information at least about the availability of upcoming egress points is consistently provided to motorists.

### BRIEF SUMMARY OF THE INVENTION

The present invention is a framework for roadway and traffic management that provides connected, automatically-updated indicators on roadway signage. This framework improves upon existing roadway signage by incorporating visual indicators, such as LED-based lights next to each indicia that identifies each upcoming exit to indicate the availability of specific exits. The framework utilizes a central roadway information management system to model various types of inputs to assess traffic conditions on a roadway, and control which visual indicator is activated next to each exit in a coordinated manner. Each roadway sign has one or more lights next to exit names, and these lights are electronically coordinated across a broader network of signage boards to provide consistent information to motorists. The status of an exit—for example, whether open, closed, congested, or subject a hazard—is indicated by the illumination of its associated LED light. The framework models traffic conditions from multiple types of input data. This may include GPS and other types of real-time to notify drivers of upcoming congested exits, improving road safety and traffic management.

It is therefore one object of the present invention to provide enhancements to existing traffic management systems. It is another object of the present invention to provide an approach for modeling various types of traffic data to assess traffic conditions and determine a traffic status for a roadway network. It is still a further object of the present invention to utilize the traffic status to warn motorists of traffic conditions at various points on the roadway network, such as specific points of egress. It is still another object to provide an approach that generates visual warning indicators on signage that also displays one or more upcoming points of egress. It is still a further object of the present invention to provide automatic updates to such signage so that visual warning indicators are consistently provided across multiple signs on a roadway network.

Other objects, embodiments, features and advantages of the present invention will become apparent from the following description of the embodiments, taken together with the accompanying drawings, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a system diagram illustrating elements of a framework for roadway and traffic management, according to one aspect of the present invention; and

FIG. 2 is a flow chart illustrating steps in a process for implementing a framework for roadway and traffic management, according to a further embodiment of the present invention.

### DETAILED DESCRIPTION OF THE INVENTION

In the following description of the present invention reference is made to the exemplary embodiments illustrating the principles of the present invention and how it is practiced. Other embodiments will be utilized to practice the present invention and structural and functional changes will be made thereto without departing from the scope of the present invention.

The present invention provides a framework 100 for an enhanced roadway information system with connected LED signage that represents an improvement upon traditional roadway signage in a dynamic approach to informing motorists about the availability of specific exits, or points of egress from the roadway, in real-time. The present invention integrates LED (or other) lights next to each listed egress point on roadway signs, providing a visual indicator that ensures that motorists and other users of the roadway are clearly and safely informed about the status of an egress point or exit.

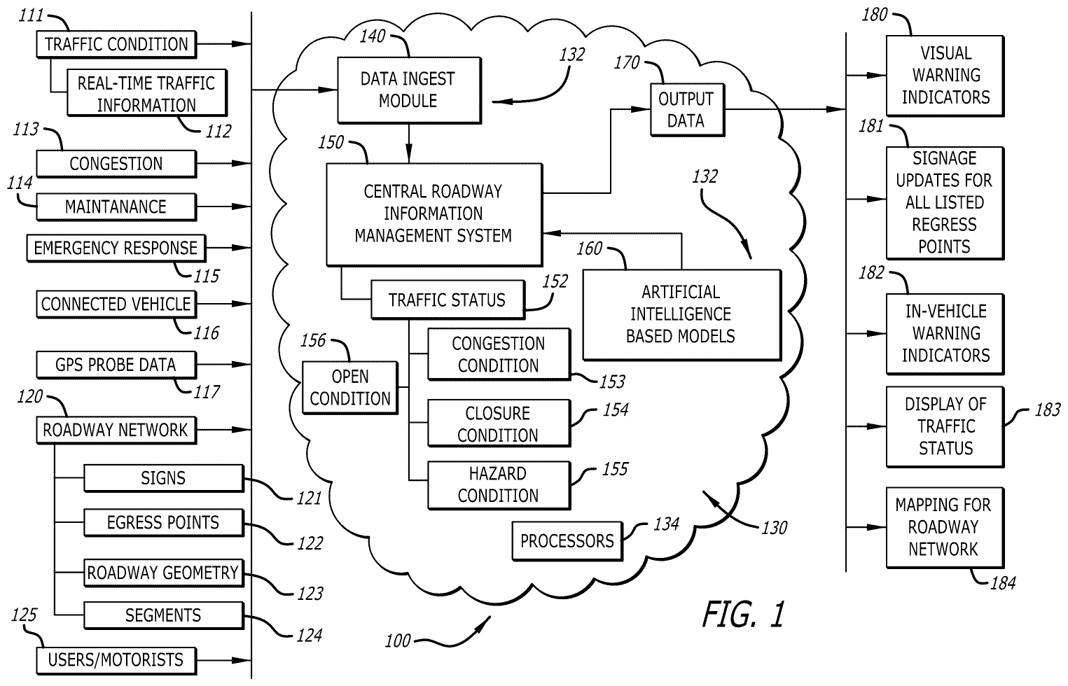

FIG. 1 is a system diagram illustrating elements of such a framework 100 according to one aspect of the present invention. The framework 100 ingests, receives, requests, or otherwise obtains input data 110 from many different types of sources. Input data 110 represents traffic conditions 111 on a roadway network 120 and may be embodied in real-time or near real-time traffic information 112. Such real-time or near real-time traffic information 112 may be provided in or derived from many different types of data files and formats in which such information is maintained. Regardless, information relative to traffic conditions 111 may be represented in congestion information 113, maintenance information 114, emergency response information 115, connected vehicle information 116, and probe data 117 represented in global positioning system (GPS) or other location data from which a location of a vehicle (or other user 128 of the roadway network 120) may be derived.

A roadway network 120 in the present invention is part of a larger transportation system, and may be comprised of many thoroughfares—such as highways, freeways, roads, streets, etc. Such a roadway network 120 may have one or more ingress points (entrances) and one or more egress points 122 (exits). The roadway network 120 may also have signage, in or more signs 121) positioned at least near such egress points 122 that advise users/motorists 12 of information such as the name of upcoming egress points 122 and the distance to such egress points 122. Such signage may display information about multiple egress points 122.

A roadway network 120 may be defined by roadway geometry 123. Roadway geometry 123 includes lane-related characteristics representing physical infrastructure and attributes, such as a number of lanes in the roadway, presence of additional lanes for bicyclists or public transport vehicles, turn lanes, angles, angles between approaches to egress points 122, and any intersection-specific complexity where lanes or links may cross each other that are relative to a traffic status 152 at or near an egress point 122. A roadway network 120 may also be comprised of one or more links or segments 124. Roadway geometry 123 and segments 124 help to define attributes of the roadway network 120 and may provide additional information to analyze the traffic conditions 111 in the real-time traffic information 112 for modeling a traffic status 152 for each of the specific egress points 122, to assess whether the traffic conditions exceed a threshold for a congestion condition 153, a closure condition 154, a hazard condition 155, or an open condition 156 at the specific egress points 122.

Congestion information 113 is information about traffic conditions 111 that represents congestion on the roadway network 120. Congestion information 113 may include information indicating, for example, a temporary or permanent drop in capacity on the roadway network 120 that may be indicative of formation of a queue at or near an egress point 122 or that traffic is either moving slower than an expected speed for a particular time of day. Congestion information 113 may be derived from different sources, such as for example sensors in or near the roadway, or connected vehicle data 116 that provides information about vehicular speed at or near an egress point 122. Other data may also be used to analyze congestion and generate congestion information 113 for the traffic conditions 111, such as crowd-sourced data from motorists or others present in a vehicle; such crowd-sourced data may be combined with information such as Bluetooth-data to determine location of devices used to generate crowd-sourced data.

Maintenance information 114 is information about traffic conditions 111 that represents maintenance activity on the roadway network 120 that produces a reduction in vehicular speed, a formation of a queue, or stopped vehicles at or near an egress point 122. Maintenance information 114 may be derived from different sources, such as for example sensors in or near the roadway, or connected vehicle data 116 involving vehicles supporting maintenance activity that provides information about the presence of maintenance vehicles at or near an egress point 122 that suggests that traffic conditions are abnormally slow. Maintenance information 114 may also include data representing planned maintenance activity for a particular segment 124 of a roadway network 120 that may produce a temporary closure of an egress point 122, or expected reduction in capacity at or near an egress point 122. Other data may also be used to analyze congestion from maintenance information 113 for the traffic conditions 111, such as crowd-sourced data from motorists or others present in a vehicle; such crowd-sourced data may be combined with information such as Bluetooth-data to determine location of devices used to generate crowd-sourced data.

Emergency response information 115 is information about traffic conditions 111 that represents activity of involving an emergency response on the roadway network 120 that produces a reduction in vehicular speed, a formation of a queue, or stopped vehicles at or near an egress point 122. Emergency response information 115 may be derived from emergency vehicles (in connected vehicle data 116) or from devices or communications associated with emergency response personnel; as with congestion information 113 and maintenance information 114, emergency response information 115 may also be provided by sources such as such as crowd-sourced data from motorists or others present in a vehicle. Such crowd-sourced data may be combined with information such as Bluetooth-data to determine location of devices used to generate crowd-sourced data.

Connected vehicle information 116 includes any information generated by a vehicle itself, such as for example information generated by a system coupled to a vehicle's Controller Area Network (CAN) bus that provides information at least about a location and a speed for a particular vehicle.

Probe data 117 is global positioning system (GPS) data from which traffic speed on a roadway network 120 may be extracted. Such data is provided as vended dataset by GPS firms, may be provided in either a raw or unprocessed form, or in pre-processed form such that traffic speed is already known. Regardless, probe data 117 may also be used to analyze traffic conditions 111 and model a traffic status 152 to assess whether a congestion condition 153, a closure condition 154, a hazard condition 155, or an open condition 156 exists for a specific egress point 122 on a roadway network 120.

Still other types of input data 110 are possible, and within the scope of the present invention. For example, weather information may be ingested into the framework 100 and used to analyze traffic conditions 111. Weather information may include meteorological data representing current (real-time) or forecasted weather over a period of time. Such weather information may be analyzed to determine whether climatological conditions are having an impact on traffic status 152 that result in one or more of a congestion condition 153, a closure condition 154, a hazard condition 155, or an open condition 156.

The framework 100 is embodied within one or more systems and/or methods that are performed in a plurality of data processing modules 132 that are components within a computing environment 130 that also includes one or more processors 134 and a plurality of software and hardware components. These data processing modules 132 may be configured to run within external cloud computing environments (and accessed therefrom by the framework 100), and also may be configured to run locally on devices hosting the framework 100, such as on mobile computing devices, “smart” phones, earphones or earbuds, on other wearable, internet-enabled devices such watches and eyeglasses, and in automotive platforms. Still further, one or more of the data processing modules 132 may be configured to run within, and executed on, edge computing environments and be responsive to natural language instructions, either verbal, written, or gesture-based. The one or more processors 134 and plurality of software and hardware components are configured to execute program instructions or routines to perform the elements, modules, components, and functions described herein that together comprise and are embodied within the plurality of data processing modules 132. The words “module” and “modules” as used herein, may refer to (and the data processing modules 132 may themselves comprise, at least in part) logic embodied in hardware or firmware, or to a collection of software instructions, written in a programming language, such as, for example, Java, Python, C, or assembly. One or more software instructions for such modules 132 may be embedded in firmware. It will be appreciated that the functional data processing modules 132 may include connected logic modules, such as gates and flip-flops, and may include programmable modules, such as programmable gate arrays or processors. The data processing modules 132 described herein may be implemented as either software and/or hardware modules and may be stored in a storage device. It is to be additionally understood that the data processing modules 132, and the respective components of the present invention that together comprise the specifically-configured elements, may interchangeably be referred to as “components,” “modules,” “algorithms” (where appropriate), “engines,” “networks,” and any other similar term that is intended to indicate an element for carrying out a specific data processing function.

One such data processing module 132 is data ingest module 140. Regardless of type, format, source, or content, the data ingest module 140 ingests, receives, requests, or otherwise obtains the input data 110 for further processing. Such processing occurs within a central roadway information management system 150 that is configured to analyze traffic conditions 111 in the real-time traffic information 112 and model a traffic status 152.

The central roadway information management system 150 applies various modeling approaches to analyze the input data 110 and assess traffic conditions 111 extracted from real-time traffic information 112. The central roadway information management system 150 determines whether one or more specific egress points 122 on the roadway network 120 are open, congested or closed, by modeling the input data 110 to determine a traffic status 152 for each of the one or more specific egress points 122. In one embodiment of the present invention, the traffic status 152 is used to assess whether the traffic conditions 111 exceed a threshold for a congestion condition 153 or a closure condition 154 at the one or more specific egress points 122. The traffic status 152 may also be used to assess whether a hazard condition 155 (for example, specifically due to roadway maintenance activity or emergency responder activity) exists for a specific egress point 122, or open condition 156 exists for a specific egress point 122.

The central roadway information management system 150 generates output data 170 representing the traffic status 152. Output data 170 may be embodied in several forms as discussed further herein. Output data 170 may thought of a series of instructions to perform some physical-world action, and/or perform automated (or non-automated) decision-making relative to the roadway network 120 (and more specifically, decision-making relative to communications about one or more specific egress points 122 on the roadway network 120), in response to the traffic status 152.

A determination by the central roadway information management system 150 of a congestion condition 153, a closure condition 154, a hazard condition 155, or an open condition 156 drives further decision-making regarding whether to activate one or more visual warning indicators 180 from the output data 170. The one or more signs 121 on the roadway network 120 may each be configured with a section next to indicia that indicates an upcoming specific egress point 122 that enables visual warning indicators 180 to be activated on the sign 121. For example, light-emitting diodes (LEDs) comprised of different colors may be configured with each sign 121. Such LEDs become visual warning indicators for whether the one or more specific egress points 122 are in a particular condition. In such an example, one visual warning indicator (for example, a red LED) may be illuminated where a congestion condition 153, closure condition 154, or a hazard condition 155 exists for the specific egress point 122; and a second visual warning indicator (for example, a green LED) may be illuminated to indicate where the one or more specific egress points 122 are in an open condition 156.

Alternatively, and in a different embodiment, only one visual warning indicator 180 may be illuminated in response to a traffic status 152. In such an embodiment, a visual warning indicator 180 is illuminated where the traffic status 152 indicates a congestion condition 153, a closure condition 154, or a hazard condition 155. Where an open condition 156 exists at the specific egress point 122, no LED is Illuminated.

It is to be understood that many configurations of LEDs as visual warning indicators are possible, including the use of differently colored LEDs, as well as LEDs that are solidly illuminated depending on the traffic status 152 and LEDs that are blinking are particular intervals depending on the traffic status 152 (where the LEDs may be differently colored, or the same color). For example, in a further alternative configuration (and additional embodiment), one visual warning indicator (for example, a yellow LED) may be illuminated where a congestion condition 153 or a hazard condition 155 exists, while a different LED color (for example, red) is illuminated for a closure condition 154, for the specific egress point 122, while no LED may be illuminated to indicate an open condition 156 for the one or more specific egress points 122. In still a further alternative configuration and embodiment where only one LED color is utilized, the LED (for example, a red LED) may be solidly illuminated (i.e. not blinking) when an egress point 122 is in a closure condition 154, illuminated but blinking when an egress point 122 is a congestion condition 153 or a hazard condition 155, or not illuminated at all when the egress point 122 is in an open condition 156.

The output data 170 may also be used to update signage across the roadway network 120, and throughout a transportation system that includes the roadway network 120. For example, signage on roadway networks 120 commonly provides indicia thereon for more than upcoming one egress point 122 (and often with a distance remaining from that signage to the egress point 122). This means that motorists are provided advance notice on more than one sign of an approaching egress point 122. In the framework 100 of the present invention, signage updates 181 are generated by the central roadway information management system 150, such that each visual warning indicators 180 for each egress point 122 are updated throughout the roadway network 120.

Accordingly, the signs 121 of a roadway network 120 are electronically and communicatively connected within the central roadway information management system 150. A visual warning indicator 180 activated for a specific egress point 122 on one sign 121 is therefore also generated for the same specific egress point 122 on other signs 121 that list the same specific egress point 122. Any change in the traffic status 152 for that specific egress point 122 that generates a different visual warning indicator 180 is made to each sign 121 where that specific egress point 122 is shown. Therefore, any signage updates 181 are made throughout the roadway network 120 via the central roadway information management system 150.

Other types of output data 170 are also possible. For example, the framework 100 may generate and provide in-vehicle warning indicators 182 to notify motorists in vehicles near or approaching a specific egress point of the traffic status 152 (where there is any of a congestion condition 153, a closure condition 154, a hazard condition 155, or an open condition 156). Such in-vehicle indicators 182 may take many forms for example, they may be visual, or aural, such that a verbal warning may be provided via an automotive platform and interface in a connected vehicle. An in-vehicle map may also be updated, to provide a display 183 of the traffic status 152 on a graphical user interface within a vehicle.

Output data 170 may also include a warning (either visual or aural or map-based) on a device associated with a motorist. For example, the central roadway information management system 150 may be configured to connect with devices (either connected to the vehicle via a Bluetooth connection, or otherwise) and provide warning indicators of a traffic status 152 via those devices. Accordingly, a display 183 of a traffic status 152 may be provided via a device, such as a mobile computing device, a “smart” phones, earphones or earbuds, or other wearable, internet-enabled devices such watches, eyeglasses, and virtual or augmented reality (or Internet-enabled) headwear, headgear, or eyeglasses.

Output data 170 may also include mapping 184 of the traffic status 152 for each egress point 122 within a roadway network 120. Such mapping 184 may be generated for a centralized display of a map of the roadway network 120 in the central roadway information management system 150.

### Machine Learning and AI Implementations

The framework 100 of the present invention may include, and invoke, one or more artificial intelligence-based models 160 for analyzing the input data 110 to assess traffic conditions 111 extracted from real-time traffic information 112 and determine a traffic status 152 for each of the one or more specific egress points 122. The one or more artificial intelligence-based models 160 may include machine learning algorithms that are applied to the input data 110 to model traffic conditions 111 based on observations and correlations between data points extracted from such input data 110, to automatically and heuristically constructing appropriate relationships between data points, mathematically or otherwise. It is to be understood that the present invention contemplates that many different types of machine learning and artificial intelligence models 160 embodying such machine learning may be employed within the scope thereof. Examples of machine learning algorithms that may be applied include, but are not limited to, k-nearest neighbor (KNN), logistic regression, support vector machines or networks (SVM), and one or more neural networks.

Neural networks may be applied in the framework 100 to identify and model appropriate relationships between data points to provide a more accurate understanding of traffic conditions 111 from the various types of input data 110, both structure and unstructured (for example, from GPS probe data 117 and from more natural language-based inputs such as information provided by motorists themselves).

Nodes are organized into multiple layers that form the neural network. There are many types of neural networks, which are computing systems that “learn” to perform tasks in a supervised manner without being programmed with task-specific rules, based on examples.

Neural networks are generally comprised of nodes, which are computational units having one or more biased input/output connections. Such biased connections act as transfer (or activation) functions that combine inputs and outputs in some way. Neural networks are based on arrays of connected, aggregated nodes (or, “neurons”) that transmit signals to each other in the multiple layers over the biased input/output connections. Connections, as noted above, are activation or transfer functions which “fire” these nodes and combine inputs according to mathematical equations or formulas. Different types of neural networks generally have different configurations of these layers of connected, aggregated nodes, but they can generally be described as an input layer, a middle or ‘hidden’ layer, and an output layer. These layers perform different transformations on their various inputs, using different mathematical calculations or functions. Signals travel between layers, from the input layer to the output layer via the middle layer, and may traverse layers, and nodes, multiple times.

Signals are transmitted between nodes over connections, and the output of each node is calculated in a non-linear function that sums all of the inputs to that node. Weight matrices and biases are typically applied to each node, and each connection, and these weights and biases are adjusted as the neural network processes inputs and transmits them across the nodes and connections. These weights represent increases or decreases in the strength of a signal at a particular connection. Additionally, nodes may have a threshold, such that a signal is sent only if the aggregated output at that node crosses that threshold. Weights generally represent how long an activation function takes, while biases represent when, in time, such a function starts; together, they help gradients minimize over time. At least in the case of weights, they can be initialized and change (i.e., decay) over time, as a system learns what weights should be, and how they should be adjusted. In other words, neural networks evolve as they learn, and the mathematical formulas and functions that comprise a neural network can change over time as a system improves itself.

Neural networks may be particularly useful in the one or more artificial intelligence-based models 160 because of their ability to model temporal characteristics of the traffic conditions 111 that give rise to determinations of the occurrence of any of a congestion condition 153, a closure condition 154, a hazard condition 155, or an open condition 156 at the specific egress points 122 from the traffic status 152. Neural networks may also incorporate a time delay, or feedback loop, which is calculated to generally account for temporal dependencies, to further improve the results of the modeling framework. This may be used by a particular type of neural network that accounts for timed data sequences, such as for example the Long-Short-Term-Memory (LSTM) neural network, discussed above. Feedback loops and other time delay mechanisms applied by the various mathematical functions of such a neural network are modeled after one or more temporally-relevant characteristics, and incorporate calculated weights and biases for variables depending on the input data collected and type of problem being analyzed.

Neural networks may be configured to address the problem of decay in longer time-dependent sequences in an architecture that has multiple, interactive components acting as “blocks” in place of the conventional layers of the neural network. Each of these blocks may represent a single layer in a middle layer, or may form multiple layers; regardless, each block may be thought of as representing different timesteps in a time-dependent sequence analysis of input data.

Supervised learning is an application of mathematical functions in algorithms that classify input data to find specific relationships or structure therein that allow the machine learning prediction engine to efficiently produce highly accurate output data. There are many types of such algorithms for performing mathematical functions in supervised learning approaches. These include regression analysis (including the logistic regression discussed above, and polynomial regression, and many others), decision trees, Bayesian approaches such as naive Bayes, support vector machines, random forests, anomaly detection, etc.

Recurrent neural networks are a name given to types of neural networks in which connections between nodes follow a directed temporal sequence, allowing the neural network to model temporal dynamic behavior and process sequences of inputs of variable length. These types of neural networks are deployed where there is a need for recognizing, and/or acting on, such sequences. As with neural networks generally, there are many types of recurrent neural networks.

Neural networks having a recurrent architecture may also have stored, or controlled, internal states which permit storage under direct control of the neural network, making them more suitable for inputs having a temporal nature. This storage may be in the form of connections or gates which act as time delays or feedback loops that permit a node or connection to retain data that is prior in time for modeling such temporal dynamic behavior. Such controlled internal states are referred to as gated states or gated memory, and are part of long short-term memory networks (LSTMs) and gated recurrent units (GRUs), which are names of different types of recurrent neural network architectures. This type of neural network design is utilized where desired outputs of a system are motivated by the need for memory, as storage, and as noted above, where the system is designed for processing inputs that are comprised of timed data sequences. Examples of such timed data sequences include video and speech recognition—where processing requires an analysis of data that changes temporally. In the present invention, where output data is in the form of predicted or forecasted future state of some condition, an understanding of the influence of various events on a state over a period of time lead to more highly accurate and reliable predictions or forecasts.

Many other types of recurrent neural networks exist. These include, for example, fully recurrent neural networks, Hopfield networks, bi-directional associative memory networks, echo state networks, neural Turing machines, and many others, all of which exhibit the ability to model temporal dynamic behavior. Any instantiation of such neural networks in the present invention may include one or more of these types, and it is to be understood that neural networks applied within the machine learning prediction engine may include different ones of such types. Therefore, the present invention contemplates that many types of neural networks may be implemented, depending at least on the type of problem being analyzed.

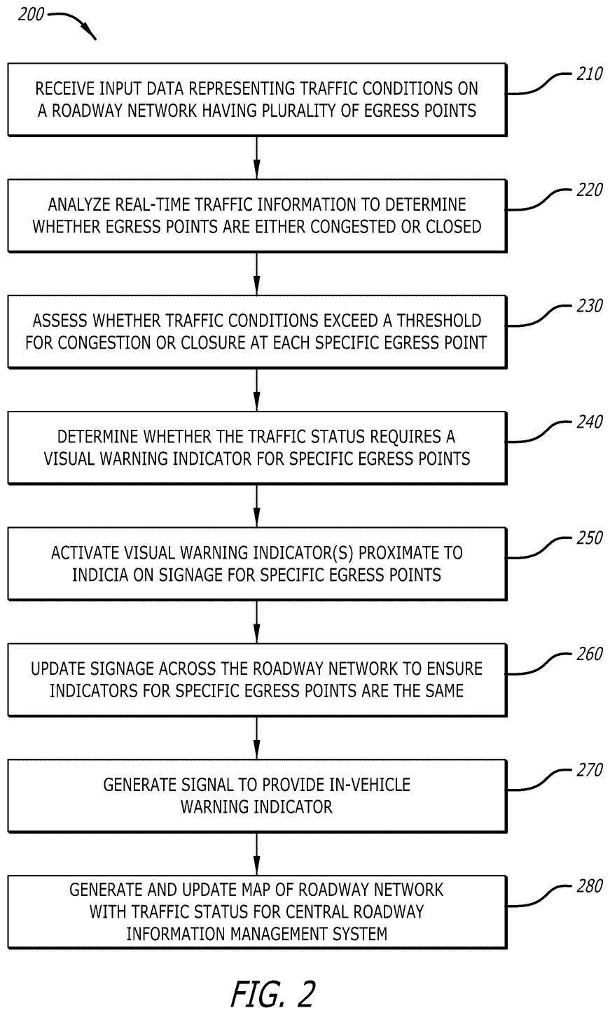

### FIG. 2

FIG. 2 is a flow chart illustrating steps in a process 200 for implementing the framework 100 according to another embodiment of the present invention. In the process 200, input data 110 representing traffic conditions 112 on a roadway network 120 having a plurality of egress points 122 (or, exits from a roadway) is received at step 210. At step 220, the process 200 begins extracting and analyzing real-time traffic information 112 from input data 110 to determine whether particular egress points 122 are congested, closed, open, or subject to a hazard condition (for example, from maintenance or emergency responder activity).

At step 230, the process 200 uses the real-time traffic information 112 to assess, in one embodiment of the present invention, whether traffic conditions 111 exceed a threshold for congestion or closure at each specific egress point 122. Traffic conditions 111 may have a normal or expected speed for a particular segment 124 of the roadway network 120 comprising specific egress points 122, depending on factors such as the day of the week, the time of day, the weather, etc., and such factors may be used to establish a range of speeds for vehicles at or near egress points 122. A threshold may be set within the central roadway information management system 150, such that anything outside a lower end of the range of speeds is a threshold for determining whether at least a congestion condition 153 or a closure condition 154 exists for an egress point 122. Regardless, the process assesses traffic conditions 111 to determine a traffic status 152 for the egress point 122.

Regardless, the process 200 then determines whether the traffic status 152 requires a visual warning indicator 180 for specific egress points 122 at step 240. If there is a determination that visual warning indicator 180 is needed, one or more of such visual warning indicators 180 proximate to indicia for specific egress points 122 are activated at step 240. The process 200 also continually updates signage throughout the roadway network 120 to ensure that indicators providing a warning for motorists for each egress point 122 are the same, at step 260. This step ensures that different signs 121 in the roadway network 120 have a uniform indication of a status of each egress point 122 (for example, available or unavailable, congested or not congestion, closed or open, etc.).

The process 200 may also include, at step 270, generating signals to provide in-vehicle warning indicators 182 as discussed above, and additionally, may further include, at step 280, generating both displays 183 of traffic status 152 (either in-vehicle, on devices, or on a dashboard at the central roadway information management system 150), and maps 184 of traffic status 152 for specific egress points 122 (again, either in-vehicle, on devices, or on a dashboard at the central roadway information management system 150). The process 200 may also include continually updating displays 183 and maps 184 as input data 110 is ingested and modeled, as well as continually updating visual warning indicators 180.

The systems and methods of the present invention may be implemented in many different computing environments. For example, the various algorithms embodied in the data processing elements may each be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, and any comparable means. In general, any means of implementing the methodology illustrated herein can be used to implement the various aspects of the present invention. Exemplary hardware that can be used for the present invention includes computers, handheld devices, telephones (e.g., cellular, Internet enabled, digital, analog, hybrids, and others), and other such hardware. Some of these devices include processors (e.g., a single or multiple microprocessors), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be partially implemented in software that can be stored on a storage medium, executed on a programmed general-purpose computer with the cooperation of a controller and memory, a special purpose computer, a microprocessor, or the like. In these instances, the systems and methods of this invention can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, artificial intelligence, fuzzy logic, expert system or combination of hardware and software that is capable of performing the data processing functionality described herein.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. For example, audio and video files may be provided to the framework 100 as input data 110, for example via accounts on social media platforms, and such audio and video files may be analyzed to assess traffic conditions 111 and determine a traffic status 152 for specific egress points 122. Additionally, natural language processing tools may be applied to this type of input data 110 via the one or more artificial intelligence-based models 160 for analyzing the information therein. It is therefore intended that the scope of the invention be limited not by this detailed description. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A method, comprising:
receiving input data representing traffic conditions on a roadway network having a plurality of egress points;
analyzing the real-time traffic information to determine whether one or more specific egress points on the roadway network are either congested or closed, by modeling a traffic status for each of the one or more specific egress points, to assess whether the traffic conditions exceed a threshold for a congestion condition or a closure condition at the one or more specific egress points;
activating one or more visual warning indicators proximate to indicia on signage notifying users of the roadway network of one or more specific egress points, wherein the one or more visual warning indicators provide an indication to the users of the roadway network of an availability of the one or more specific egress points in response to the traffic status, the one or more visual indicators notifying the users with a first visual indicator where the traffic status exceeds the threshold for the congestion condition or the closure condition at the one or more specific egress points, and with a second indicator where the traffic status does not exceed the threshold the congestion condition or the closure condition at the one or more specific egress points; and
updating the signage across the roadway network so that all signage showing the same one or more specific egress points has the same one or more visual warning indicators.

2. The method of claim 1, wherein the input data represents traffic conditions including real-time traffic information on the roadway network, the real-time traffic information including congestion information, maintenance information, and emergency response information.

3. The method of claim 2, wherein the congestion information represents traffic speeds that are lower than a threshold level below a posted speed limit for an area of the roadway network proximate to the one or more specific egress points.

4. The method of claim 2, wherein the emergency response information represents activity involving emergency response vehicles for an area of the roadway network proximate to the one or more specific egress points.

5. The method of claim 2, wherein the maintenance information represents roadway maintenance activity occurring in an area of the roadway network proximate to the one or more specific egress points.

6. The method of claim 5, wherein the assigning the traffic status for each of the one or more specific egress points further includes analyzing the traffic conditions to assess whether traffic exceeds a threshold for a hazard condition due to the roadway maintenance activity at the one or more specific egress points, and wherein the one or more visual indicators notify the users with the first visual indicator where the traffic status exceeds the threshold for the hazard condition.

7. The method of claim 1, wherein the signage is comprised of a plurality of signs positioned at particular points on the roadway network prior to the one or more specific egress points, such that the plurality of signs advise roadway users of the one or more specific egress points, and wherein the one or more specific egress points are linked on the plurality of signs, so that the central roadway management system provides a real-time update on each sign for the availability of the one or more specific egress points indicated thereon.

8. The method of claim 1, wherein the one or more visual warning indicators are electronic indicators positioned proximate to each name of a specific egress point on the signage.

9. The method of claim 1, wherein the one or more visual warning indicators are illuminated LED lights comprised of different colors that provide the first visual indicator to indicate whether the one or more specific egress points are in the congestion condition or the closure condition, and the second visual indicator to indicate whether the one or more specific egress points are in an open condition.

10. The method of claim 1, further comprising transmitting a warning indicator for the one or more specific egress points to one or more vehicles on the roadway network proximate to the one or more specific egress points.

11. The method of claim 1, wherein the input data includes one or more of connected vehicle data transmitted from one or more vehicles on the roadway network proximate to the one or more specific egress points, GPS probe data representing a location of one or more vehicles on the roadway network, and roadway geometry data defining characteristics of the roadway network, the characteristics including a number and a location of the one or more specific egress points.

12. An apparatus, comprising:
a central roadway information management system, configured to analyze input data representing traffic conditions on a roadway network having a plurality of egress points to determine whether one or more specific egress points on the roadway network are either congested or closed, by assigning a traffic status for each of the one or more specific egress points, the traffic status determined by analyzing the traffic conditions to assess whether traffic exceeds a threshold for a congestion condition or a closure condition at the one or more specific egress points; and
one or more visual warning indicators proximate to indicia on signage notifying users of the roadway network of one or more specific egress points, wherein the one or more visual warning indicators provide an indication to the users of the roadway network of an availability of the one or more specific egress points in response to the traffic status, the one or more visual indicators notifying the users with a first visual indicator where the traffic status exceeds the threshold for the congestion condition or the closure condition at the one or more specific egress points, and with a second indicator where the traffic status does not exceed the threshold the congestion condition or the closure condition at the one or more specific egress points, and
wherein the central roadway information management system updates the signage across the roadway network so that all signage showing the same one or more specific egress points has the same one or more visual warning indicators.

13. The apparatus of claim 12, wherein the input data represents traffic conditions including real-time traffic information on the roadway network, the real-time traffic information including congestion information, maintenance information, and emergency response information.

14. The apparatus of claim 13, wherein the congestion information represents traffic speeds that are lower than a threshold level below a posted speed limit for an area of the roadway network proximate to the one or more specific egress points.

15. The apparatus of claim 13, wherein the emergency response information represents activity involving emergency response vehicles for an area of the roadway network proximate to the one or more specific egress points.

16. The apparatus of claim 13, wherein the maintenance information represents roadway maintenance activity occurring in an area of the roadway network proximate to the one or more specific egress points.

17. The apparatus of claim 16, wherein the central roadway information management system is further configured to analyze the traffic conditions to assess whether traffic exceeds a threshold for a hazard condition due to the roadway maintenance activity at the one or more specific egress points, and wherein the one or more visual indicators notify the users with the first visual indicator where the traffic status exceeds the threshold for the hazard condition.

18. The apparatus of claim 12, wherein the signage is comprised of a plurality of signs positioned at particular points on the roadway network prior to the one or more specific egress points, such that the plurality of signs advise roadway users of the one or more specific egress points, and wherein the one or more specific egress points are linked on the plurality of signs, so that the central roadway management system provides a real-time update on each sign for the availability of the one or more specific egress points indicated thereon.

19. The apparatus of claim 12, wherein the one or more visual warning indicators are electronic indicators positioned proximate to each name of a specific egress point on the signage.

20. The apparatus of claim 12, wherein the one or more visual warning indicators are illuminated LED lights comprised of different colors that provide the first visual indicator to indicate whether the one or more specific egress points are in the congestion condition or the closure condition, and the second visual indicator to indicate whether the one or more specific egress points are in an open condition.

21. The apparatus of claim 12, wherein the central roadway information management system is further configured to transmit a warning indicator for the one or more specific egress points to one or more vehicles on the roadway network proximate to the one or more specific egress points.

22. The apparatus of claim 12, wherein the input data includes one or more of connected vehicle data transmitted from one or more vehicles on the roadway network proximate to the one or more specific egress points, GPS probe data representing a location of one or more vehicles on the roadway network, and roadway geometry data defining characteristics of the roadway network, the characteristics including a number and a location of the one or more specific egress points.
